(19) United States
(12) Patent Application Publication
(10) Pub. No.: US 2009/0169983 A1
(43) Pub. Date: Jul. 2, 2009

(54) BATTERY WITH A PHASE-CHANGING MATERIAL

(76) Inventors: Ajith Kuttannair KUMAR, Erie, PA (US); John D. BUTINE, Erie, PA (US)

Correspondence Address: General Electric Company;GE Global Patent Operation, PO Box 861, 2 Corporate Drive, Suite 648, Shelton, CT, 06484, US

(21) Appl. No.: 11/965,035

(22) Filed: Dec. 27, 2007

(51) Int. Cl. H01M 10/50; H01M 10/36

(52) U.S. Cl. 429/120; 429/149

(57) ABSTRACT

Batteries containing phase-changing materials are disclosed for improved heating and cooling capabilities so as to minimize unnecessary operating temperature swings, increase heating and cooling uniformity and reduce heating and cooling requirements. The phase changing materials may be disposed on containers located underneath a button sheet, above a plurality of cells, on an inner casing of the battery, and/or on a cooling plate of the battery.

### BACKGROUND OF THE INVENTION

### Field of the Invention

The embodiments disclosed relate generally to batteries and more particularly to batteries including a phase-changing material.

In electric vehicles and in hybrid electric vehicles and non-vehicle applications (e.g., locomotives, off-highway mining vehicles, marine applications, cranes, buses, and automobiles), batteries are essential components used to store a portion of the energy that is regenerated during braking for later use during motoring or generated for later use when the demand is low, thus increasing fuel efficiency.

FIG. 1 illustrates an inner assembly 10 of a conventional battery 11 and FIG. 2 shows across-sectional view of the conventional battery 11 having the inner assembly 10 of FIG. 1. As illustrated, the inner assembly 10 of the conventional battery 11 includes a base plate 12, also known as a button sheet, having a plurality of buttons or protrusions 13 configured to hold a plurality of cells 14 electrically connected to each other by a plurality of bus bars (not shown). Separating groups of cells 14, a plurality of cooling ducts or plates 16 supplied with air from a cooling header 18 is designed to maintain the cells 14 within a desired operating temperature range.

As it will be apparent to one of ordinary skill, FIG. 1 is presented for the purpose of illustrating components of the conventional battery 11, including only a small number of cells 14, for better clarity of the other features illustrated and described, and should not be considered as limiting the different embodiments of the invention disclosed or as an illustration of a commercial product. For example, in some conventional batteries, different than what is illustrated in FIG. 1, a cooling plate 16 is provided between each two rows of cells 14.

As illustrated in FIG. 2, mica sheets 20 are packed between adjacent cells 14 so as to insulate the cells 14 from each other and from the mechanical packaging of the conventional battery 11. The mechanical packaging of the conventional battery 11 also includes an inner casing 22, which envelops the inner assembly 10, separated from an outer casing 24 by a layer of insulation material 26. Typically, the space between the inner casing 22 and the outer casing 24 is evacuated in order to minimize heat transfer to and/or from the battery.

In general, battery-operating environments are harsh due, at least in part, to large changes in environmental temperature commonly encountered. In addition, charge and discharge are accomplished under severe conditions, including significant changes in battery operating temperatures due to large amounts of discharging current at the time of acceleration of a vehicle and large amounts of charging current at the time of breaking. In addition, optimum performance requires that these batteries be maintained uniformly within a given temperature range, which depends on the type of battery used, thus requiring that cooling and/or heating be provided. Many different types of batteries are known to exits; however, current high-temperature batteries, such as, for example and not a limitation. Sodium Nickel Chloride batteries, have to be heated to operating temperatures above 270° C. In the conventional battery 11, cooling is accomplished with airflow through the cooling plates 16, as explained, and an electric heater 28 is provided to raise the temperature of the battery to the desired operating level.

FIG. 3 illustrates a qualitative temperature history of the conventional battery 11 from startup to shutdown. Initially, the battery is heated from an initial temperature to a minimum operating temperature T₁, at which time the battery heating system is turned off and the battery is allowed to operate. As already explained, normal use of the battery causes its temperature to increase to a maximum operating temperature T₃, at which time a battery cooling system is activated so as to prevent overheating. Normally a maximum temperature, Tₘₐₓ, may also exist above which the battery is not allowed to operate in order to avoid unnecessary damage thereto. Once the battery temperature reaches a level at which no further cooling is needed, at T₂, the cooling system is turned off. For purposes of illustration FIG. 3 illustrates only a single heating/cooling cycle. As one of ordinary skill will appreciate, under normal operating conditions, the temperature of the conventional battery will increase and decrease between T₃ and T₁ and several cooling/heating cycles may take place. As also shown in FIG. 3, once the battery is turned off, its temperature drops down to ambient temperature and the battery has to be heated again once operation restarts.

As the size of the conventional battery 11 increases, it becomes more difficult to heat or cool the battery uniformly by use of the electric heater 28 and cooling plates 16 and a significant amount of energy and/or large airflow rates are required to provide the needed heating and/or cooling, respectively. It would therefore be desirable to develop a battery with improved heating and cooling capabilities so as to minimize unnecessary operating temperature swings, increased heating and cooling uniformity and reduced heating power and cooling requirements, among other advantageous characteristics.

### BRIEF SUMMARY OF THE INVENTION

One or more of the above-summarized needs or others known in the art are addressed by batteries that include a plurality of cells and a container having a phase-changing material, the phase-changing material being configured to melt when an operating temperature of the battery is above a threshold temperature and to solidify when the operating temperature of the battery is below the threshold temperature.

Batteries according to embodiments of the disclosed inventions also include a plurality of cells, a heater disposed above the plurality of cells and a container having a phase-changing material therein disposed adjacent to the heater.

Batteries according to embodiments of the disclosed inventions also include a plurality of cells and an inner casing surrounding the plurality of cells, the inner casing further including a container having a phase-changing material therein.

Batteries according to embodiments of the disclosed inventions also include a plurality of cooling plates and a plurality of cells disposed between adjacent cooling plates, at least one cooling plate including a phase-changing material.

Batteries according to embodiments of the disclosed inventions also include a plurality of cooling plates, a plurality of cells disposed between adjacent cooling plates, a plurality of insulating sheets disposed between the plurality of cells, a plurality of bus bars interconnecting the plurality of cells, an inner casing surrounding the plurality of cooling plates, the plurality of cells, the plurality of insulating sheets, and the plurality of bus bars, an outer casing surrounding the inner casing so as to form a gap there between, a layer of insulating material disposed inside at least a portion of the gap, and means for delaying and/or averaging cooling and/or heating requirements of the battery over a period of time of operation of the battery.

The above brief description sets forth features of the various embodiments of the present invention in order that the detailed description that follows may be better understood, and in order that the present contributions to the art may be better appreciated. There are, of course, other features of the invention that will be described hereinafter and which will be for the subject matter of the appended claims.

In this respect, before explaining several embodiments of the invention in detail, it is understood that the various embodiments of the invention are not limited in their application to the details of the construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which the disclosure is based, may readily be utilized as a basis for designing other structures, methods, and/or systems for carrying out the several purposes of the present invention. It is important, therefore, that the claims be regarded as including such equivalent constructions insofar as they do not depart from the spirit and scope of the present invention.

Further, the purpose of the foregoing Abstract is to enable a patent examiner and/or the public generally, and especially scientists, engineers and practitioners in the art who are not familiar with patent or legal terms or phraseology, to determine quickly from a cursory inspection the nature and essence of the technical disclosure of the application. Accordingly, the Abstract is neither intended to define the invention or the application, which only is measured by the claims, nor is it intended to be limiting as to the scope of the invention in any way.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 illustrates a perspective view of an inner assembly of a conventional battery;

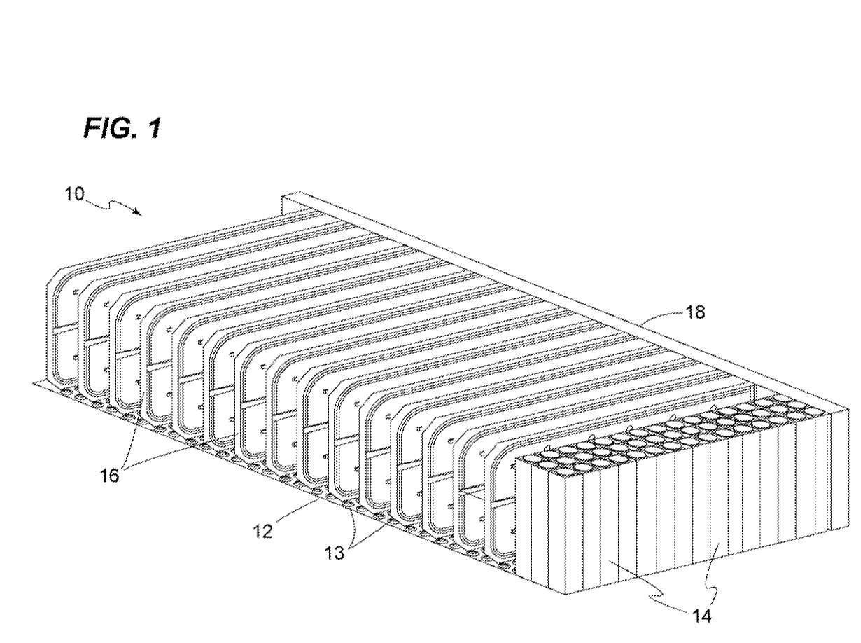

FIG. 2 illustrates a cross-sectional view of a conventional battery having the inner assembly of FIG. 1 taken along a direction perpendicular to the cooling plates;

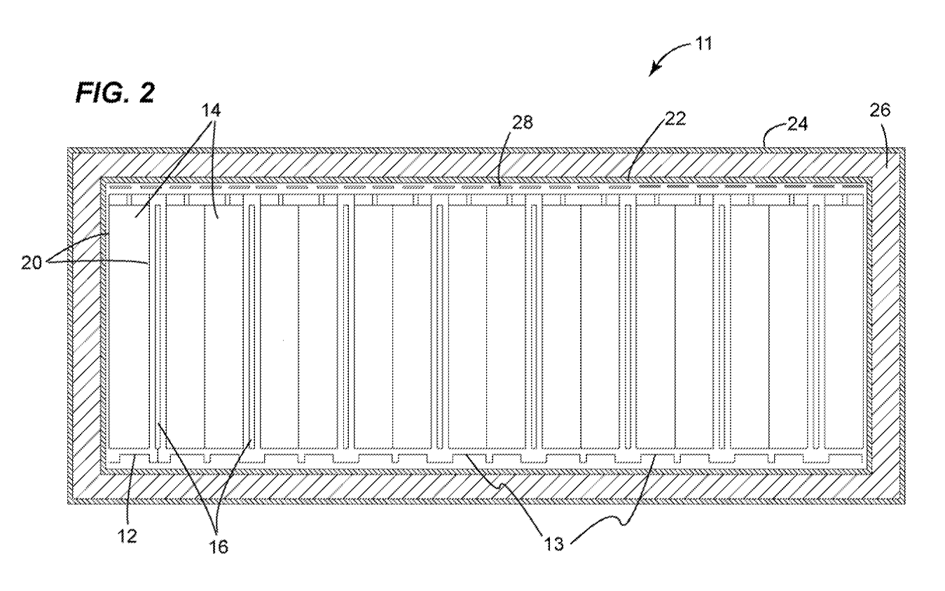

FIG. 3 illustrates a qualitative time history of the temperature of the conventional battery having the inner assembly of FIG. 1;

FIG. 4 illustrates a cross-sectional view of a battery according to an embodiment of the subject matter disclosed;

FIG. 5 illustrates a cross-sectional view of a battery according to another embodiment of the subject matter disclosed;

FIG. 6 illustrates a cross-sectional view of a battery according to yet another embodiment of the subject matter disclosed;

FIG. 7 illustrates a cross-sectional view of a battery according to yet another embodiment of the subject matter disclosed;

FIG. 8 illustrates a cross-sectional view of a battery according to yet another embodiment of the subject matter disclosed; and

FIG. 9 illustrates a qualitative time history of the temperature of a battery having any of the embodiments shown in FIGS. 4-8.

### DETAILED DESCRIPTION OF THE PREFERRED EMBODIMENTS

Embodiments of the subject matter disclosed relate generally to batteries and more particularly to batteries with phase-changing materials. By use of phase-change materials incorporated into the battery improved heating and cooling capabilities so as to minimize unnecessary operating temperature swings, increase heating and cooling uniformity, reduce heating and cooling requirements, and increased operating range/time are accomplished either individually or in any combination, among other advantageous features, as will be apparent to those of ordinary skill based on the subject matter disclosed. In addition, those of ordinary skill will appreciate that the various embodiments disclosed herein to maintain the temperature of a battery uniformly are not dependent on each other, i.e., each may be implemented without the other and various combinations are within the scope of the subject matter disclosed, as it will become apparent. Referring now to the drawings, wherein like reference numerals designate identical or corresponding parts throughout the several views, several embodiments of the improved batteries will be described.

Generally, the subject matter disclosed relates to a batten 30 that includes a phase-change material disposed therein configured to change phase as the temperature of the battery changes during operation such that, as the phase change process takes place, the battery temperature will not change substantially, thus maintaining a desired uniform level. Given the fact that for a given mass the amount of latent energy associated with a phase change process is large compared to the sensible energy associated with an increase or decrease of temperature, the use of the phase-change material will minimize unnecessary battery operating temperature swings during use, while increasing heating and cooling uniformity, reducing heating and cooling requirements because large temperature drops and/or spikes will be minimized and/or eliminated, and increasing operating range/time while reducing cooling requirements.

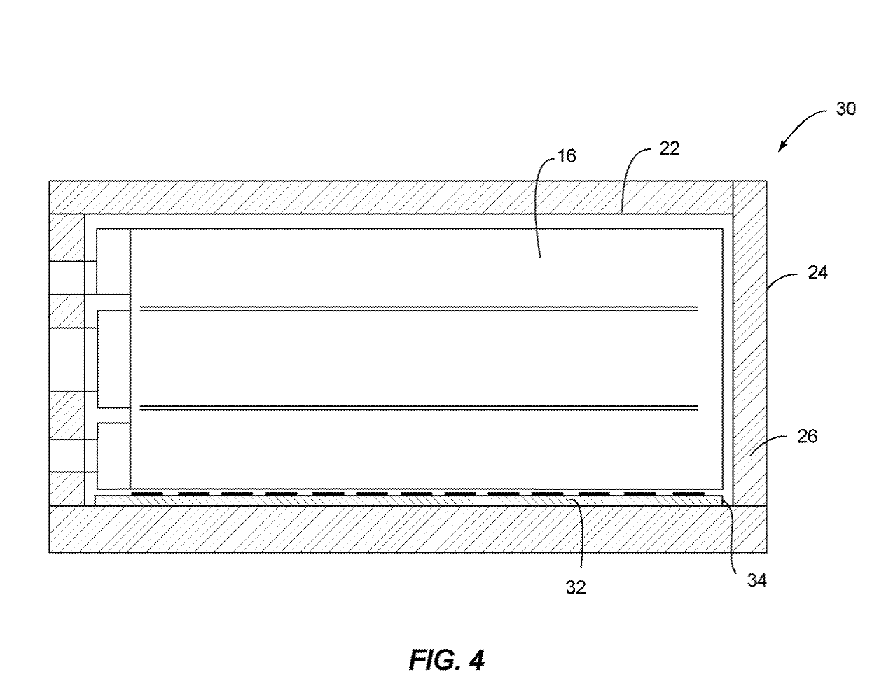

FIGS. 4-7 illustrate cross-sectional views of a battery 30 taken along the cooling plate 16, including several exemplary embodiments of the disclosed subject matter. As shown, generally, the battery 30 includes the button sheet 12, the inner casing 22, the outer casing 24, and the insulating material 26. However, as it will be clearly understood by those of ordinary skill in the application arts, the elements just summarized are not limiting in any way on the subject matter disclosed.

In the embodiment of FIG. 4, a phase-change material 32 is disposed inside of a sealed container 34 disposed below the button sheet 12. In order to allow for the expansion of the phase-change material 32 during phase change, the sealed container 34 is configured so as to provide for expansion, as for example, it may include an air gap. Also, the sealed container 34 may extend continuously underneath the button sheet 12 or discretely. Also, the sealed container 34 may extend continuously or several discrete sealed containers 34 may be disposed below the button sheet 12 separated from each other by a fixed or variable distance.

The phase-change material 32 may be selected based on the desired operating temperature of the battery 30. Examples include lead with a melting temperature around 327 C for a battery, which typically operates in the 270 C to 360 C, or many different kinds of wax for room temperature batteries.

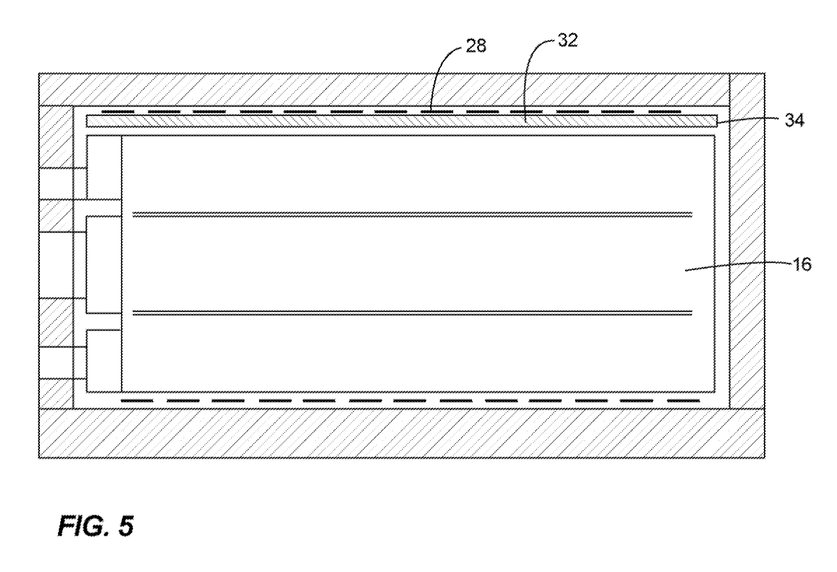

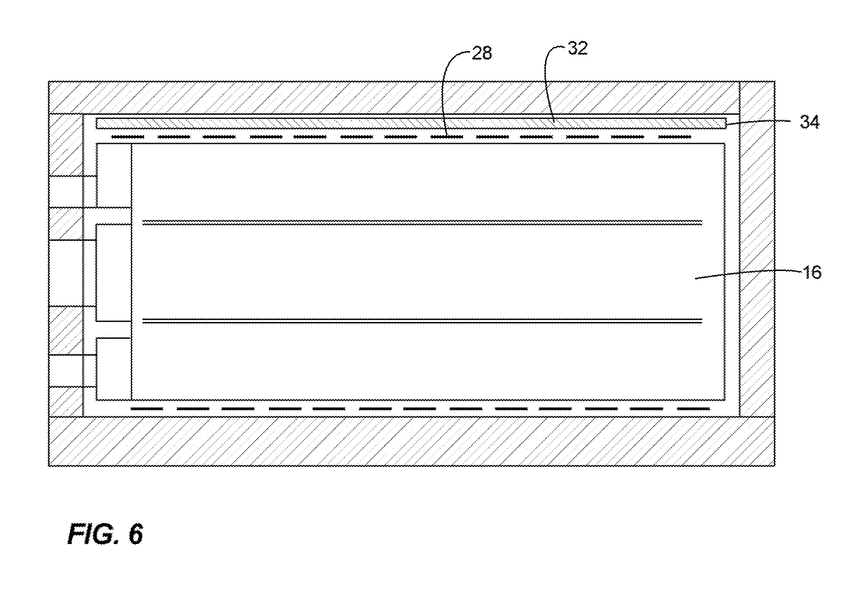

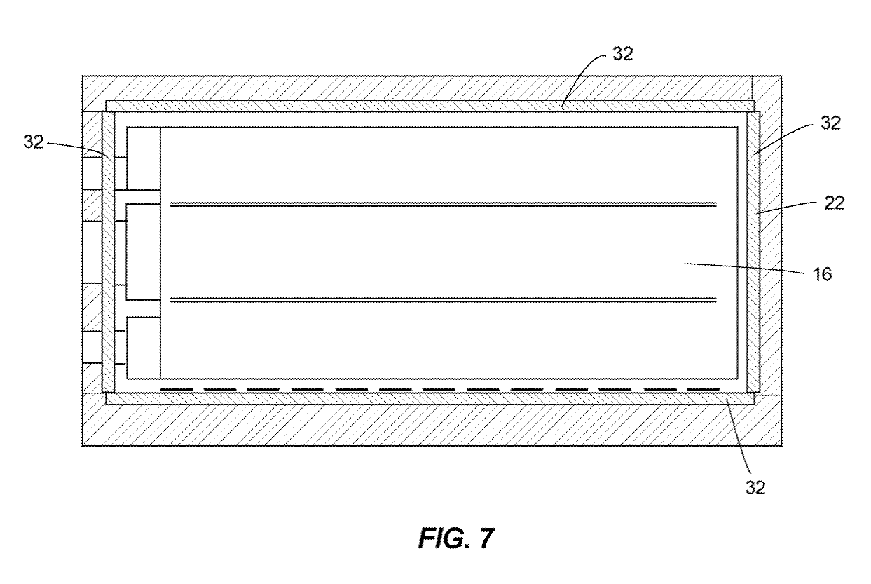

In the embodiments illustrated in FIGS. 5 and 6, the sealed container 34 of the phase-change material 32 is disposed on top of the cooling plates 16 either below or/and above of the heater 28, respectively. In FIG. 7, the sealed container 34 of phase-change material 32 is added to any or all sides of the inner casing 22. The amount and location of the phase change material depends on the cost/size/cooling control. For example if external cooling is provided only thru the bottom wall, then only phase change material at or near the bottom plate can be provided. The phase-changing material may also be used to equalize the temperature of the battery as well as for structural support. In one of the embodiments of FIG. 7, the inner casing 22 is a double walled case inside of which the phase-change material 32 is disposed with provision for expansion, including an air gap. Also, the sealed container 34 may extend continuously or several discrete sealed containers 34 may be disposed on top or below the heater 28 separated from each other by a fixed or variable distance.

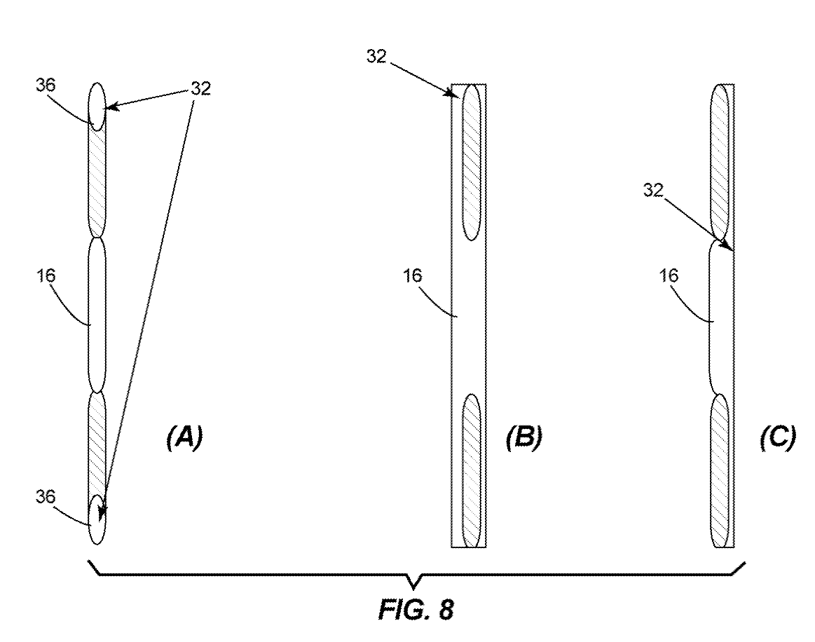

FIGS. 8A-8C illustrate various embodiments of the subject matter disclosed in which the phase-change material 32 is disposed inside or around the cooling plate 16. In FIG. 8A, a sealed tube 36 containing the phase-changing material 32 is disposed horizontally inside the cooling plate 16. Although the embodiment disclosed in FIG. 8A illustrates the sealed tube 36 disposed at the extremities of the cooling plate 16, the sealed tube 36 could be disposed horizontally inside the cooling plate 16 in any location. In the FIG. 8B, the cooling plate 16 is enclosed within the phase-changing material 32. In FIG. 8C, one side of the cooling plate 16 is enclosed within the phase-changing material 32. Optionally, in the embodiments of FIGS. 8B and 8C, the cooling plate 16 may provide for expansion, if needed during the phase-changing process. The amount of material provided, depends on the amount of transient energy storage required and also the amount of heat transfer required. For example 8B provides a temperature equalizing since the battery cells will be very close to the phase change material where as 8A, some of the energy transferred to the phase change material comes thru the cooling medium.

As it will be appreciated by those of ordinary skill in the applicable arts, the subject matter disclosed herein related to the use of a phase change material to control the operating temperature of a battery as well as to control temperature uniformity inside of the battery is not limited by the exemplary embodiments illustrated in FIGS. 4-8. For example, the phase change material may equally be used in other batteries, such as, but not limited to, lithium Ion batteries, NiMH batteries, to name just a few examples for locomotive and other applications where the internal battery generated heat can melt a phase change material and can be cooled at a slower rate, thus limiting the upper and/or lower temperature limits. Therefore, the different ways of packaging illustrated in FIGS. 4-6 should be considered exemplary rather than limiting, e.g., other batteries in which a phase change material may be disposed will not require, for example, a button sheet, no vacuum insulation, no double container, etc.

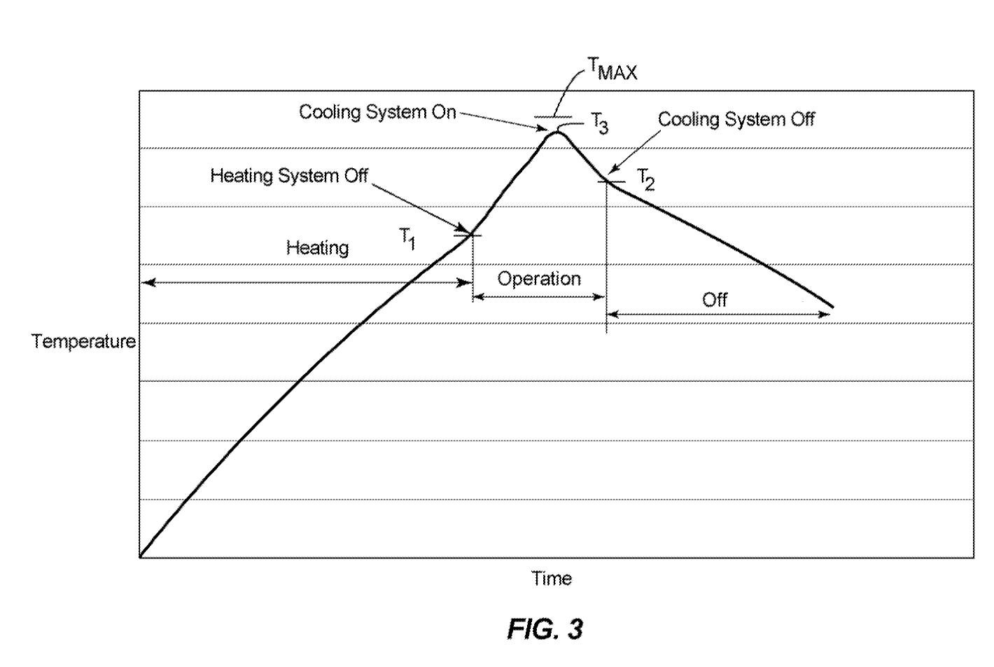

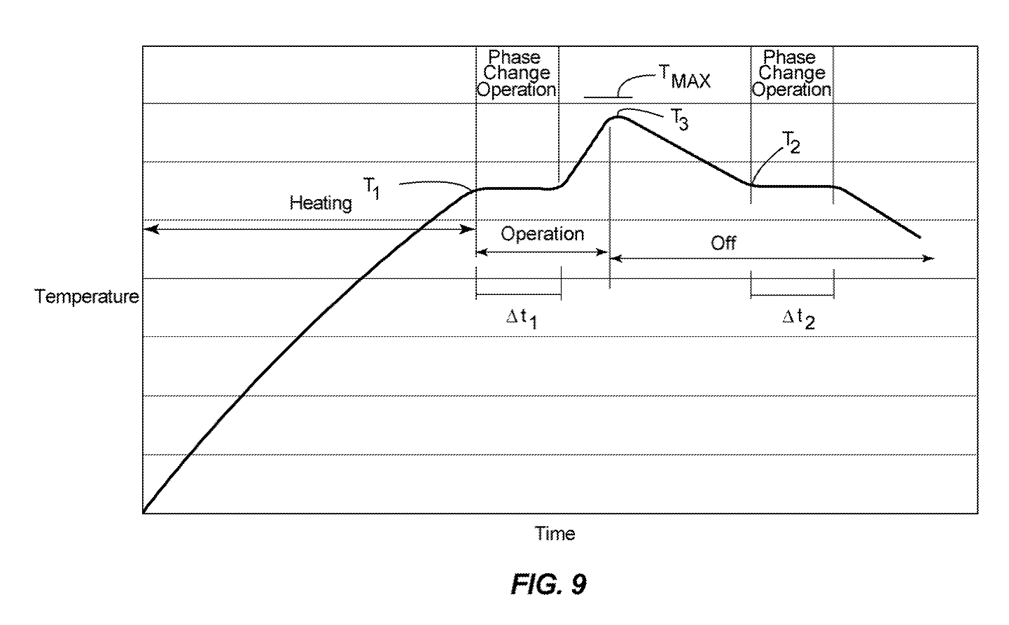

FIG. 9 illustrates a qualitative temperature history of the battery 30 from startup to shutdown including any of the embodiments of FIGS. 4-8 and their equivalents. Initially, the battery is heated from an initial temperature to a minimum operating temperature T₁, at which time the battery heating system 28 is turned off. As charging and discharging during operation heat the battery 30, the phase-changing material 32 melts, thus absorbing large amounts of energy generated during operation and preventing the temperature of the battery 30 to increase during the amount of time Δt₁. Note that the operating temperature range may be outside the T₁-T₃ as already explained. Once all of the phase-changing material 32 is molten (at the end of the time interval Δt₁) and operation continues, tire temperature of the battery 30 increases to a temperature T₃, at which time a battery cooling system is activated so as to prevent overheating by maintaining the battery operating temperature bellow Tₘₐₓ. In another embodiment, depending on the amount of phase-changing material 32, no cooling may be required. Once the battery temperature reaches a level at which no further cooling is needed, at T₁, the temperature of the battery 30 is prevented from further drops during the time interval Δt₁ as the phase-changing material 32 solidifies. As those of ordinary skill in the applicable arts will understand it, the time intervals illustrated in FIG. 9 do not necessarily need to be equal during cooling and heating. During the solidification process of the phase-changing material 32, the temperature of the battery 30 remains at T₁, thus eliminating or substantially reducing the need for heating. Eventually, once all of the phase-changing material 32 solidifies and the battery 30 is no longer in operation, the temperature drops down to room temperature. Depending on the battery operating duty cycle, the cooling requirement significantly reduces, since the amount of duration without any heating or cooling (for example comparing FIGS. 3 and 9, the duration of temperature between temperature T₀ to T₃) is significantly higher. It is also possible to provide no active cooling if there is sufficient phase change material.

As previously noted, for purposes of illustration FIG. 9 illustrates only a single heating/cooling cycle in which all of the phase-changing material 32 is either molten or solidified. As one of ordinary skill will appreciate, under normal operating conditions, the temperature of the conventional battery will increase and decrease between T₃ and T₁ and several cooling/heating cycles take place in which the amount of melting or solidification will vary. As already noted, given the fact that for a given mass the amount of latent energy associated with a phase change process is large compared to the sensible energy associated with an increase or decrease of temperature, the use of the phase-change material 32 will minimize unnecessary operating temperature swings of the battery 30 in use, while increasing heating and cooling uniformity and reducing heating and cooling requirements because large temperature drops and/or spikes will be minimized and/or eliminated. As appreciated by those of ordinary skill after consideration of the subject matter disclosed, longer times without cooling (for example, the operation of a cooling fan is minimized) and/or a battery with smaller cooling system or no cooling required is possible with the embodiments illustrated in FIGS. 4-8. Also, longer down times is also attainable when the battery 30 is turned off. Finally, in the claims attached herein below, any means-plus-function clause is intended to cover the structures described herein as performing the recited function and not only structural equivalents, but also equivalent structures.

While the disclosed embodiments of the subject matter described herein have been shown in the drawings and fully described above with particularity and detail in connection with several exemplary embodiments, it will be apparent to those of ordinary skill in the art that many modifications, changes, and omissions are possible without materially departing from the novel teachings, the principles and concepts set forth herein, and advantages of the subject matter recited in the appended claims. Hence, the proper scope of the disclosed innovations should be determined only by the broadest interpretation of the appended claims so as to encompass all such modifications, changes, and omissions.

What is claimed is:

1. A battery, comprising:
a plurality of cells electrically interconnected to each other; and
a first container having a phase-changing, wherein the phase-changing material is configured to melt when an operating temperature of the battery is above a threshold temperature and to solidify when the operating temperature of the battery is below the threshold temperature.

2. The battery according to claim 1, wherein the first container is disposed on a location selected from the group consisting of an underside section of the battery, an upside section of the battery, a side section of the battery, an intermediate section of the battery, and combinations thereof.

3. The battery according to claim 1, wherein the first container further comprises an air gap therein so as to allow for expansion and contraction of the phase-changing material.

4. The battery according to claim 1, further comprising:
a heater disposed above the plurality of cells; and
a second container having a phase-changing material therein disposed adjacent to the heater

5. The battery according to claim 1, further comprising:
an inner casing surrounding the plurality of cells; and
a button sheet to support the plurality of cells, said inner casing further comprising a second container having a phase-changing material therein.

6. The battery according to claim 4, further comprising:
an inner casing surrounding the plurality of cells; and
a button sheet supporting the plurality of cells, said inner casing further comprising a third container having a phase-changing material therein.

7. The battery according to claim 1, further comprising:
a plurality of cooling plates, each of the cooling plates being disposed adjacent a corresponding cell and comprising an inner tube having a phase-changing material therein.

8. The battery according to claim 5, further comprising:
a plurality of cooling plates, each of the cooling plates being disposed adjacent a corresponding cell and comprising an inner tube having a phase-changing material therein.

9. The battery according to claim 6, further comprising:
a plurality of cooling plates, each of the cooling plates being disposed adjacent a corresponding cell and comprising an inner tube having a phase-changing material therein.

10. A battery, comprising:
a plurality of cells electrically interconnected to each other;
a button sheet to support the plurality of cells;
a heater disposed above the plurality of cells; and
a first container having a phase-changing material therein disposed adjacent to the heater, wherein the phase-changing material is configured to melt when an operating temperature of the battery is above a threshold temperature and to solidify when the operating temperature of the battery is below the threshold temperature.

11. The battery according to claim 10, further comprising:
an inner casing surrounding the plurality of cells and the button sheet, said inner casing further comprising a second container having a phase-changing material therein.

12. The battery according to claim 11, further comprising:
a plurality of cooling plates, each of the cooling plates being disposed adjacent a corresponding cell and comprising an inner tube having a phase-changing material therein.

13. The battery according to claim 10, further comprising:
a plurality of cooling plates, each of the cooling plates being disposed adjacent a corresponding cell and comprising an inner tube having a phase-changing material therein.

14. A battery, comprising:
a plurality of cells electrically interconnected to each other; and
an inner casing surrounding the plurality of cells, said inner casing further comprising a first container having a phase-changing material therein, wherein the phase-changing material is configured to melt when an operating temperature of the battery is above a threshold temperature and to solidify when the operating temperature of the battery is below the threshold temperature.

15. The battery according to claim 14, further comprising:
a plurality of cooling plates, each of the cooling plates being disposed adjacent a corresponding cell and comprising an inner tube having the phase-changing material therein.

16. A battery, comprising:
a plurality of cooling plates; and
a plurality of cells disposed between adjacent cooling plates, wherein at least one cooling plate comprises a phase-changing material and the phase-changing material is configured to melt when an operating temperature of the battery is above a threshold temperature and to solidify when the operating temperature of the battery is below the threshold temperature.

17. The battery according to claim 16, wherein the at least one cooling plate comprises an inner tube containing the phase-changing material.

18. The battery according to claim 16, further comprising a first container in which the phase-changing material is contained, wherein the first container covers at least a portion of an outer surface of the at least one cooling plate.

19. The battery according to claim 16, wherein the first container covers an outer surface of the at least one cooling plate.

20. A battery, comprising:
a plurality of cooling plates;
a plurality of cells disposed between adjacent cooling plates;
a plurality of insulating sheets disposed between the plurality of cells;
a plurality of bus bars interconnecting the plurality of cells;
an inner casing surrounding the plurality of cooling plates, the plurality of cells, the plurality of insulating sheets, and the plurality of bus bars;
an outer casing surrounding the inner casing so as to form a gap there between;
a layer of insulating material disposed inside at least a portion of the gap; and
means for delaying and/or averaging cooling and/or heating requirements of the battery over a period of time of operation of the battery.
